(19) United States
(12) Patent Application Publication
(10) Pub. No.: US 2011/0186087 A1
(43) Pub. Date: Aug. 4, 2011

(54) PROCESS FOR PURIFYING POLYCRYSTALLINE SILICON

(75) Inventors: Hanns Wochner, Burghausen (DE); Christian Gossmann, Emmerting (DE); Herbert Lindner, Ostermiething (AT)

(73) Assignee: WACKER CHEMIE AG, Munich (DE)

(21) Appl. No.: 12/674,299

(22) PCT Filed: Aug. 8, 2008
(86) PCT No.: PCT/EP08/60423

§ 371 Date: Feb. 19, 2010

(30) Foreign Application Priority Data
Aug. 22, 2007 (DE) 10 2007 039 626.2

(51) Int. Cl. B08B 3/00

(52) U.S. Cl. 134/28

(57) ABSTRACT

Polysilicon is freed of metallic impurities without the use of HCl or H₂O₂ by a preliminary cleaning with NHO₃, HF, and H₂SiF₆ and a main cleaning with HNO₃ and HF, followed by hydrophilization. The main cleaning solution can be cycled to the process as a preliminary cleaning solution component.

The invention relates to a process for cleaning polycrystalline silicon without hydrochloric acid and without hydrogen peroxide.

For the production of solar cells or electronic components, for example memory elements or microprocessors, high-purity semiconductor material is required. The dopants introduced deliberately are the only impurities that such a material should have in the most favorable case. There is therefore an effort to keep the concentrations of damaging impurities as low as possible. It is frequently observed that even semiconductor material produced with high purity, in the course of further processing to give the target products, becomes contaminated again. Thus, costly and inconvenient purification steps are needed time and again in order to recover the original purity. Extraneous metal atoms which are incorporated into the crystal lattice of the semiconductor material disrupt charge distribution and can reduce the function of the later component or lead to the failure thereof. As a result, contaminations of the semiconductor material especially by metallic impurities should be avoided. This is especially true of silicon, which is by far the most frequently used semiconductor material in the electronics industry. High-purity silicon is obtained, for example, by thermal decomposition of silicon compounds which are volatile and therefore easy to purify by means of distillation processes, for example trichlorosilane. It is obtained in polycrystalline form, in the form of rods with typical diameters of 70 to 300 mm and lengths of 500 to 2500 mm. A large portion of the rods is used to produce crucible-pulled single crystals, ribbons and films, or to produce polycrystalline solar cell base material. Since these products are produced from high-purity molten silicon, it is necessary to melt solid silicon in crucibles. In order to make this operation as effective as possible, large-volume, solid silicon pieces, for example the polycrystalline rods mentioned, have to be comminuted before melting. This is typically always associated with surface contamination of the semiconductor material, because the comminution is effected with metallic crushing tools, such as jaw or roll crushers, hammers or chisels. These impurities consist, for example, of metal carbide or diamond residues, and metallic impurities.

During the comminution, it should carefully be ensured that the surfaces of the fragments are not contaminated with extraneous substances. More particularly, contamination by metal atoms is considered to be critical since these can alter the electric properties of the semiconductor material in a damaging manner. When the semiconductor material to be comminuted, as has predominantly been customary to date, is comminuted with mechanical tools, for example steel crushers, the fragments must be subjected to a surface cleaning step before the melting operation.

In order to be able to use mechanically processed polycrystalline silicon or polycrystalline silicon grains obtained from mechanically processed particles as core silicon to produce monocrystalline silicon as starting material, it is necessary to lower the concentration of the impurities present on the surface of the mechanically processed polycrystalline silicon.

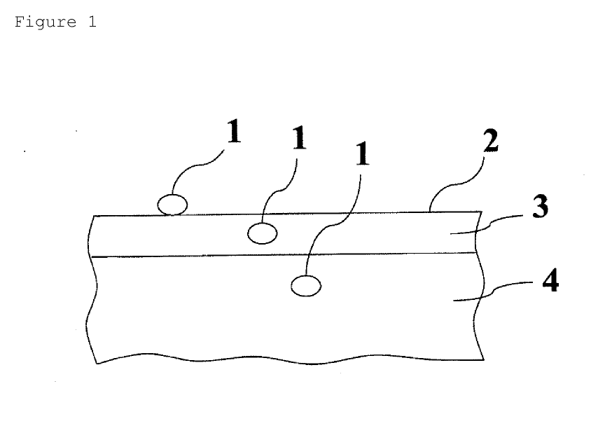

As a result of the comminution, some of the impurities in the polysilicon fragments obtained also get into deeper surface layers (FIG. 1). For example, metal particles (1) from metal carbide residues from attritus of the comminution machines, or diamond particles from the attritus of sawblades on the surface of the polysilicon not only get to the surface (2), but also into the native oxide layer (3) and into the silicon lattice (4).

To remove the impurities, for example, the surface of the mechanically processed polycrystalline silicon is etched with a mixture of nitric acid and hydrofluoric acid. In the process, the metal particles are attacked strongly by the acid mixture in the precleaning step. This leaves metal carbide residues, which are very substantially dissolved in the HF/HNO₃ main cleaning step.

DE 195 29 518 describes a cleaning process in which polycrystalline silicon is first cleaned with a mixture of aqua regia (mixture of hydrochloric acid and nitric acid) and additionally subjected to a cleaning step with hydrofluoric acid. However, this process provides only poor cleaning results.

JP 06 02 10 34 discloses a cleaning solution for semiconductor material. The cleaning solution is composed of water, 30 to 50% HNO₃ and 0.1 to 1% HF.

JP 051-54466 describes a cleaning process in which hydrofluoric acid and nitric acid are used. The remaining iron concentration in this process is no longer sufficient given the present demands on the purity of polysilicon.

EP 0905796 describes a cleaning process consisting of a precleaning step by means of a mixture consisting of HF/HCl/H₂O₂, a main cleaning step by means of HF/HNO₃ and a subsequent hydrophilization of the silicon surface by means of HCl/H₂O₂. In this process, the metal particles are strongly attacked by the acid mixture in the precleaning step. This leaves metal carbide residues, which are very substantially dissolved in the HF/HNO₃ main cleaning step.

However, a disadvantage in this process is the offgases which occur. For instance, gaseous chlorine, HF and HCl occur in the precleaning step, nitrogen oxides and HF in the main cleaning step, and chlorine gas in the hydrophilization.

Owing to the risk of formation of aqua regia, the offgas streams from the precleaning/hydrophilization step must not be disposed of by means of a common offgas disposal system. Even in small amounts, aqua regia destroys plastics, such as polypropylene (PP) or polyethylene (PE). This has the consequence that two entirely separate systems are needed to dispose of the offgases. In addition, the offgases from the precleaning and the hydrophilization have to be disposed of in a chlorine scrubber, and the offgases from the main cleaning step in a nitrogen oxide scrubber.

A further disadvantage of this process is the high specific acid consumption and the associated acid costs.

It was an object of the invention to provide a process for purifying polysilicon, in which the acid consumption is significantly lower and the problems described in the offgas disposal do not occur.

It has been found that, surprisingly, in the case of a precleaning step with a solution of hydrofluoric acid, nitric acid and hexafluorosilicic acid, it is possible to dispense with the substances hydrochloric acid and hydrogen peroxide.

The invention provides a process for cleaning polysilicon, comprising the steps of

a.) precleaning in at least one stage with an oxidizing cleaning solution comprising hydrofluoric acid, nitric acid and hexafluorosilicic acid,
b.) main cleaning in a further stage with a cleaning solution comprising nitric acid and hydrofluoric acid,
c.) hydrophilization in a further stage with an oxidizing cleaning solution.

Studies have shown that, surprisingly, precleaning with a dilute HF/HNO₃/H₂SiF₆ mixture with a low HNO₃ content leads to very good results. Preference is given to an HNO₃ content of 5 to 35% by weight of the cleaning solution.

It was thus surprisingly possible to find, for the inventive composition of the cleaning solution, a concentration range which, with regard to the dissolution rates of metals and silicon, achieves values just as good as the precleaning steps with a solution of HF/HCl/H₂O₂ described in the prior art (EP 0905796).

The attack on the steel particles by the presence of hydrofluoric acid and especially of hexafluorosilicic acid is surprisingly not impaired in a dilute HNO₃ solution.

The precleaning step can be effected at temperatures of 0 to 60° C. The precleaning step is preferably conducted at a temperature of 10 to 40° C., more preferably at 20 to 30° C.

The hydrophilization can take place in an aqueous ozone solution, without presence of hydrogen peroxide. In the inventive multistage cleaning process, the offgases can all be disposed of together by means of a nitrogen oxide scrubber. Dispensing with hydrochloric acid and hydrogen peroxide in the cleaning process allows the chlorine scrubber for the offgas to be dispensed with. The capital costs for the overall process fall considerably as a result.

In one embodiment of the cleaning process according to the invention, the precleaning step and the main cleaning step can take place in separate acid circuits. For the individual steps, fresh cleaning solutions are prepared in each case. The acid concentrations required are established in a controlled manner through replenishment with hydrofluoric acid and nitric acid.

A particular embodiment of the cleaning process is effected in the form of a cascade between the precleaning step and main cleaning step. In this case, the waste acid comprising HF, HNO₃/HNO₂ and H₂SiF₆ which arises from the main cleaning step is used again in the precleaning step. The use of such a cascade with reuse of the acids allows the specific acid consumption of the overall process to be lowered significantly.

The invention will be illustrated in detail by the examples which follow.

The metal analyses on cleaned crushed poly were carried out as follows:

In a Teflon funnel, 100 g of heavy polysilicon were squirted with 40 ml of a mixture of HF/HNO₃ in a ratio of 1:4. The etching acid was collected in a Teflon cup. Subsequently, the acid was evaporated off and the residue was taken up in 5 ml of water. The metal content of the aqueous solution is measured on an ICP-AES (inductively coupled ion plasma atomic emission spectroscope) from Spectro. The metal content of the poly surface was calculated from the values measured. The data are in pptw.

### EXAMPLE 1

### Cleaning of Crushed Poly in a Precleaning Step with an Acid Mixture of HF/HNO₃/H₂SiF₆

A polysilicon rod was comminuted and classified by means of an apparatus composed of a comminution tool and a screening apparatus. 5 kg of crushed poly were treated in a process dish by the following three-stage cleaning process. The precleaning step and the main cleaning step were effected in separate acid circuits. For precleaning, the crushed polysilicon was cleaned in a mixture of 30% by weight of HNO₃, 6% by weight of HF, 1% by weight of Si and 0.5% by weight of HNO₂ at a temperature of 25° C. for 20 minutes. The removal of the polysilicon surface was 1μ.

In the subsequent main cleaning, the crushed polysilicon was etched at 8° C. in a mixture of HF/HNO₃ with 6% by weight of HF, 55% by weight of HNO₃ and 1% by weight of Si for 5 minutes. This etching removed approx. 30 μm. This was followed by rinsing with 18 megaohm ultrapure water at a temperature of 22° C. for 5 minutes. The crushed polysilicon was subsequently cleaned in a further step in a mixture of HF/ozone with 2% by weight of HF and 20 ppm of ozone for 5 minutes, and then rinsed for a further 5 minutes. Finally, the crushed polysilicon was hydrophilized in water with 20 ppm of ozone at a temperature of 22° C. for 5 minutes and dried with class 100 ultrapure air at 80° C. for 60 minutes.

The following metal surface values were obtained:

| Element | Concentration | Element | Concentration |
|---|---|---|---|
| Fe | 26.72 pptw | Ti | 14.10 pptw |
| Cr | 9.86 pptw | W | 1.52 pptw |
| Ni | 2.68 pptw | K | 29.33 pptw |
| Na | 38.80 pptw | Co | 0.56 pptw |
| Zn | 18.47 pptw | Mn | 3.15 pptw |
| Al | 40.24 pptw | Ca | 53.06 pptw |
| Cu | 0.69 pptw | Mg | 10.00 pptw |
| Mo | 0.62 pptw | V | 1.44 pptw |

### COMPARATIVE EXAMPLE 1

The procedure was as in example 1, except that, as known from EP 0905796, a mixture consisting of HF/HCl/H₂O₂ was used for precleaning step, HF/HNO₃ for the main cleaning step, and HCl/H₂O₂ for subsequent hydrophilization of the silicon surface.

The following metal surface values were obtained:

| Element | Concentration | Element | Concentration |
|---|---|---|---|
| Fe | 28.59 pptw | Ti | 15.86 pptw |
| Cr | 12.08 pptw | W | 2.73 pptw |
| Ni | 7.72 pptw | K | 42.98 pptw |
| Na | 40.98 pptw | Co | 0.18 pptw |
| Zn | 7.90 pptw | Mn | 1.75 pptw |
| Al | 45.56 pptw | Ca | 60.97 pptw |
| Cu | 1.58 pptw | Mg | 16.60 pptw |
| Mo | 0.16 pptw | V | 1.48 pptw |

### EXAMPLE 2

### Cleaning of Crushed Poly in a Precleaning Step with an Acid Mixture of HF/HNO₃/H₂SiF₆ in an Etching Cascade

The procedure was analogous to example 1. However, the precleaning step and the main cleaning step are connected to one another. After the main cleaning step, the acid from the main cleaning step flows into the precleaning step and is used there for precleaning. To adjust any deviating acid concentrations, the required acid can be metered in as necessary.

1.-6. (canceled)

7. A process for cleaning polysilicon without the use of HCl and H₂O₂, comprising the steps of:
a) precleaning in at least one stage with an oxidizing cleaning solution comprising hydrofluoric acid, nitric acid and hexafluorosilicic acid,
b) main cleaning in a further stage with a cleaning solution comprising nitric acid and hydrofluoric acid,
c) hydrophilization in a further stage with an oxidizing cleaning solution
wherein that the acid from the main cleaning step is reused in the precleaning step.

8. The process as claimed in claim 7, wherein the cleaning solution in the precleaning step has an HNO₃ concentration in the range from 5 to 35% by weight.

9. The process of claim 7, wherein the precleaning step takes place at a temperature of 0 to 60° C.

10. The process of claim 8, wherein the precleaning step takes place at a temperature of 0 to 60° C.

11. The process of claim 7, wherein hydrophilization is performed in an aqueous ozone solution.

12. The process of claim 8, wherein hydrophilization is performed in an aqueous ozone solution.

13. The process of claim 9, wherein hydrophilization is performed in an aqueous ozone solution.

14. The process of claim 10, wherein hydrophilization is performed in an aqueous ozone solution.

15. The process of claim 7, wherein a precleaning step and a main cleaning step take place in separate acid circuits.

16. (canceled)
